(19) United States
(12) Patent Application Publication
(10) Pub. No.: US 2021/0256712 A1
(43) Pub. Date: Aug. 19, 2021

(54) On-Demand Image Based Location Tracking Platform

(71) Applicant: Bridgewest Ventures LLC, San Diego, CA (US)

(72) Inventor: Saeid Safavi, San Diego, CA (US)

(21) Appl. No.: 17/143,059

(22) Filed: Jan. 6, 2021

Related U.S. Application Data
(63) Continuation-in-part of application No. 16/355,443, filed on Mar. 15, 2019.
(60) Provisional application No. 62/643,501, filed on Mar. 15, 2018.

(51) Int. Cl. G06T 7/246; G06T 7/292

(52) U.S. Cl. CPC G06T 7/246; G06T 2207/30248; G06T 2207/30181; G06T 7/292

(57) ABSTRACT

An image processing system comprising several drones flown over a geographic region is disclosed. In some embodiments, the geographic region is within the cell coverage area of a cellular transmission tower. In some embodiments, the cellular transmission tower is capable of communicating over a cellular telephone network with a cellular telephone transceiver within a lead drone. In some such embodiments, one or more of the drones has a camera capable of taking a relatively high resolution photograph of the earth and the features on the earth below the drones. The area of the earth that the camera can capture may include the area directly under each of the other drones. The image can then be compared to other images. Using image recognition algorithms, the processor can identify a target asset and track the target asset based on the comparison of images.

### CROSS-REFERENCE TO RELATED APPLICATIONS—CLAIM OR PRIORITY

The present application is a continuation-in-part of, and claims the benefit of priority under 35 USC § 120 of, commonly assigned and co-pending prior U.S. application Ser. No. 16/355,443, filed Mar. 15, 2019, entitled “On-Demand Outdoor Image Based Location Tracking Platform”, the disclosure of which is incorporated herein by reference in its entirety. Application Ser. No. 16/355,443 claims priority to U.S. Provisional Application No. 62/643,501, filed on Mar. 15, 2018, entitled “On-Demand Outdoor Image Based Location Tracking Platform”, which is herein incorporated by reference in its entirety.

### BACKGROUND

### (1) Technical Field

Various embodiments described herein relate to systems and methods for performing position location and more particularly for accurate positioning and location tracking of objects and people in indoor and outdoor environments.

### (2) Background

The demand for accurate positioning and location tracking has been increasing due to a variety of location-based applications that are becoming important in light of the rise of smart cities, connected cars and the “Internet of Things” (IoT), among other applications. People are using position location for everything from tagging the location at which pictures were taken to personal navigation. More and more, companies integrate location-based services into their platforms to enhance productivity and predictability of their services.

In most cases, the means used by applications that need to know the location of a device requires local receivers with access to the Global Positioning System (GPS). Other competing global navigation satellite systems also exist, such as GLONASS, et al. One major draw-back to such global navigation satellite systems, such as the current GPS based systems, is that they all need a relatively sensitive GPS receiver located on the tracked object. This is not necessarily efficient, practical or otherwise viable, particularly in critical situations like security threats or emergency scenarios, such as natural disasters, etc. Furthermore, there are situations in which it is difficult to receive the necessary signals transmitted by the satellites of the current global navigation satellite systems. This could be due to the inherent difficulties that exist when attempting to receive satellite signals using a satellite receiver that is located indoors or in the presence of obstructions to satellite signals, such tall buildings, foliage, etc.

In addition, most target assets (e.g., objects and people) require a transmitter to be collocated with the target asset and to send information attained by the target asset to a processing system that then evaluates the transmitted information. The need for a transmitter increases the power consumption, cost and complexity of the equipment that is present with the target asset.

Therefore, there is a need for a system for locating and tracking target assets without the need for a transmitter or receiver on the tracked target asset.

### DESCRIPTION OF THE DRAWINGS

FIG. 1 is an illustration of one example of a system in accordance with the disclosed method and apparatus.

FIG. 2 is an illustration of an indoor camera mounted on a wall in the interior of a building.

FIG. 3 is an illustration of a system in accordance with an embodiment of the disclosed method and apparatus.

FIG. 4 shows an example of 2D rotation-based location tracking steps when the area of interest is directly below the field of view of a camera.

FIG. 5 shows an example of 3D rotation-based location tracking steps when the area of interest in not below the field of view of a camera and with an arbitrary slant angle.

Like reference numbers and designations in the various drawings indicate like elements.

### DETAILED DESCRIPTION

The presently disclosed method and apparatus uses various hardware devices and hardware platforms together with software algorithms to identify, locate and/or track target assets. In some embodiments, digital signal processing and image processing are used to perform the desired tasks. In some embodiments, target assets include objects such as, but not limited to, vehicles, electronic devices, automobile keys, people, etc. Some embodiments of the disclosed method and apparatus provide location-based services without requiring complex, expensive or cumbersome devices to be associated with target assets. Such embodiments eliminate the need for a tracking device, transmitter or receiver to be carried by, affixed to, or otherwise be present on, or at the location of, a target asset.

The disclosed method and apparatus can also assist with various related applications, such as identifying particularly interesting situations and opportunities. In some embodiments, these opportunities and situations include identifying the location of an empty parking space, finding a particular building based on an image of the building or an image that is on or near the building without the system knowing the address of the building, identifying and finding lost or mislaid articles within a closed environment, etc. In some embodiments, the unique structure or identifying features of a building, such as a sign with the name of a company or other entity that occupies the building is used to find the building. In some embodiments, image processing-based technology is used to accurately identify and/or locate target assets. Some such embodiments of the disclosed method and apparatus use artificial intelligence (AI) to help locate or identify target assets. In other embodiments, techniques that do not rely upon AI are used.

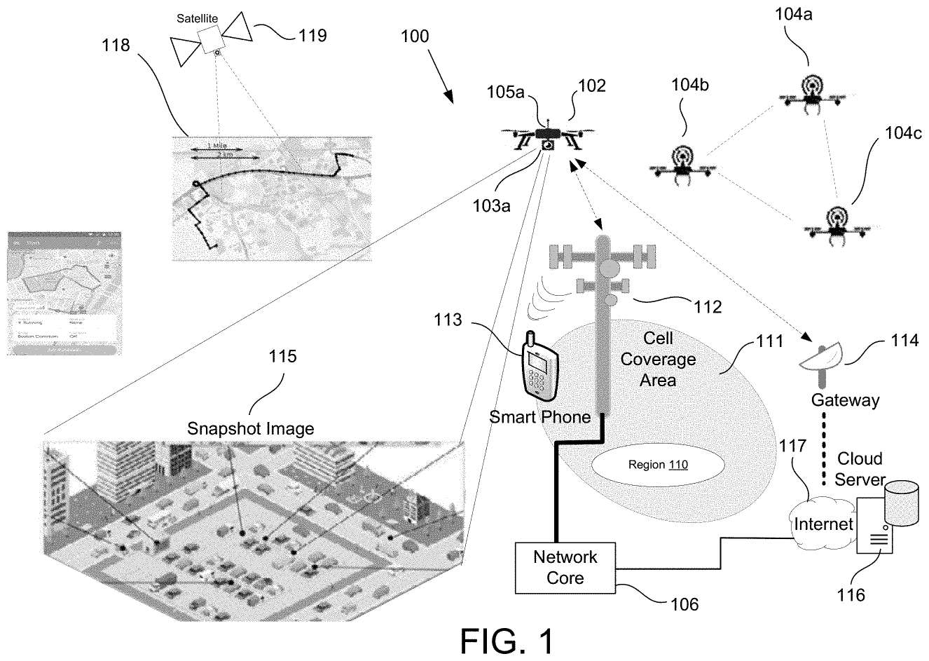

FIG. 1 is an illustration of one embodiment of the disclosed method and apparatus. A system 100 uses one or more cameras 103, in accordance with the disclosed method and apparatus. In some embodiments, cameras 103a are mounted on one or more drones 102, 104 that flown over a geographic region 110. In some such embodiments, a lead drone 102 has a processor that allows the lead drone 102 to control and coordinate the operation of secondary drones 104. In the example shown, a lead drone 102 is expressly shown to have a camera 103a. However, secondary drones 104 may also have cameras that have not been shown in the figures for the sake of simplicity.

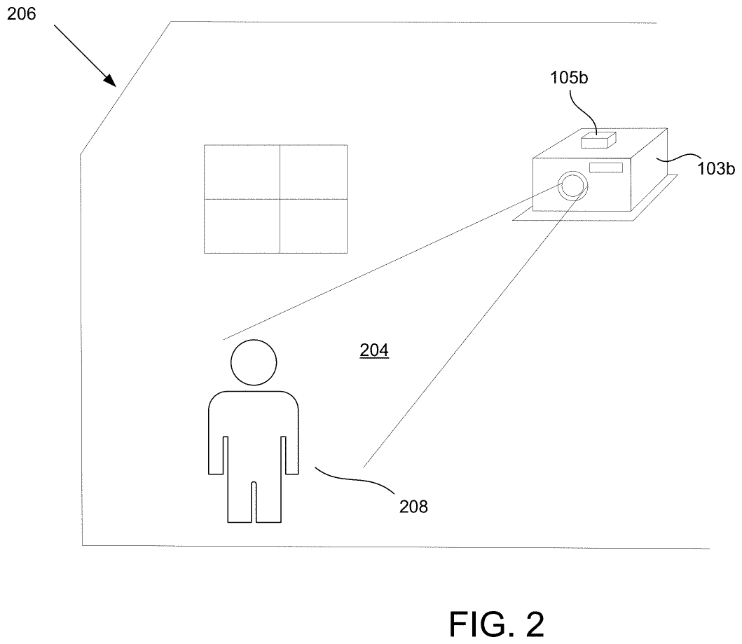

It should be noted that throughout this disclosure, reference indicators used in the figures may include numeric characters followed by an alphabetic character, such as 103a in which the numeric characters “103” are followed by the alphabetic character “a”. Reference indicators having the same numeric characters refer to features of the figures that are similar, either structurally or functionally or both. For example, the cameras 103a, 103b perform similar functions, however each camera 103 may be associated with a mounting. Furthermore, similar features may be referenced collectively using only the numeric characters of the reference indicator. For example, in the present disclosure, “cameras 103” refers to the drone mounted cameras 103a and to any other cameras, such as a wall mounted camera 103b shown in FIG. 2.

In some embodiments, the geographic region 110 is within a cellular coverage area 111 of a cellular transmission tower 112. The cellular transmission tower 112 facilitates communication between a cellular telephone core network 106 and various communication modules 105 within components (such as the communication module 105a in the lead drone 102, smart phones 113, etc.) of the system 100. In some embodiments, the core network 106 provides the communication modules 105 with access to cloud based services, cloud connected devices (such as a cloud server 116), and other communication networks.

In some embodiments of the disclosed method and apparatus, the drone cameras 103 are used to determine a relatively rough estimate of the location of a target asset. Once the target asset is detected by processing of the picture from the on-drone camera, depending on the drone height and field of view, a coarse estimation of on-ground location of the target can be determined. Once the general location of the field of view of the camera is identified, an image of an area map covering the pictured region can be extracted from APIs of map services (e.g., google maps). In some cases, such extraction can be performed automatically. Alternatively, an image of the relevant area map can be extracted from a region database. Once the image of the relevant map is obtained, the mentioned image rotation algorithms, scaling and image fitting processes can fit the image of the map into the picture and then perform fine localization of the target asset. In some embodiments, such services are provided by a processor within the cloud server 116.

The tracked target asset is localized by taking the pictures of the field of view, rotating (and in some embodiments scaling the information provided in the picture) to fit the image of the map (e.g., information attained from Google Maps) and deducting the object location by image recognition.

In other embodiments, the drone is equipped with an accurate location tracking system so that the location of the drone can be accurately determined (e.g., using a satellite position location system, terrestrial triangulation, drone triangulation, other position location techniques, or a combination of one or more of these.).

The disclosed method and apparatus is capable of providing very accurate real time location information about a target asset. In addition, the disclosed method and apparatus can be used to find a specific object or person by matching the information derived from pictures taken by a camera to a database and using object or pattern recognition algorithm to locate the target asset. After locating the target asset, the system 100 can follow the target asset. In some embodiments in which a drone is used to support the camera, the drone can move accordingly to maintain visual contact with the target asset.

The area of the earth that the camera can capture may include the entire area directly under all of the drones. Alternatively, the image taken by the camera may capture the geographic region under only the drone with the camera or the area under a subset of the drones 102, 104.

In other embodiments, the secondary drones 104 are outside the area captured by the image taken with the camera in the lead drone 102, at least for some portion of the time during which the drones are providing information for use by the system 100 and possibly for the entire time. Nonetheless, in some embodiments, each of the secondary drones 104 can communicate with the lead drone 102. In some such cases, each secondary drone 104 can also communicate with the other secondary drones 104. In some embodiments, such communication is over the cellular telephone network or over a local area network. In other embodiments, other communication systems can be used either instead of, or in addition to a cellular telephone network. As will be explained below in greater detail, the existence of several drones on top of the region of interest improves, and in some cases simplifies, the ability to fit the image of the map into the picture taken. In some embodiments in which a drone takes a picture of the area underneath the drone, the picture needs to be rotated by a 2D rotation mechanism. When the camera is above the area of interest (or tracking area) the image of the map can be fitted to the picture resulting from the cameras' view of the region of interest. Each pixel within the picture is then given a coordinate based on the coordinates for corresponding features in the image of the map.

For example, using a 4 k camera on a drone which is flying at 100 m above an area of interest could give around less than lm per pixel location tracking accuracy (dependent on field of view). This is better than you would get from a GPS unit (depending on hardware and coordinate systems, etc.).

When the picture is taken from areas beyond the immediate area below the drone, a 3D rotation may be required. 3D rotation is usually more complicated and may require artificial intelligence to help with the image-map matching process.

In some embodiments, the lead drone 102 may also communicate with an internet gateway 114. The internet gateway 114 provides a means by which a picture of a scene 115 taken by the camera 103 within the lead drone 102 (and possible images taken by cameras 103 within the secondary drones 104 or mounted on fixed mounts either indoors or outdoors) can be transmitted to a cloud based server 116 or other resources within the cloud over the internet 117. The image can then be compared to another image 118, such as an image taken by a satellite 119. Using image recognition algorithms, the processor 116 within the cloud can then identify a target asset, such a person running a marathon and track the target asset based on the comparison of images captured by the camera within the drones 102, 104 and images and other feature data known to the processor 116 by independent means.

FIG. 2 is an illustration of an indoor camera 103b mounted on a wall 204 in the interior of a building 206. In some embodiments, the system 100 uses a combination of indoor cameras 103b and outdoor cameras 103a to capture information.

In some embodiments, cameras 103 reside at known locations and are capable of communicating with other components of the system 100 through an associated communication module 105. In some embodiments, at least one of the communication modules 105 is integrated into one or more associated cameras 103 to which the communication module 105 is electronically coupled. In such embodiments, other communication modules 105 may be outside the camera 103, but integrated into a component of the system 100, such as a drone 104 in which the camera 103 also resides, and electronically coupled to an associated camera 103. In some embodiments, one communication module 105 may be electronically coupled to, and provide wireless access for, several associated cameras 103. The system 100 can use cameras 103 that are on fixed platforms (such as the wall mounted camera 103b in FIG. 2) or on mobile platforms (such as the camera 103a mounted on the drone 102 in FIG. 1).

In some embodiments, components of the system 100 communicate with one another wirelessly, such as through the cellular network or over a local area network (LAN) using WiFi, or other wireless communication systems. The location of the cameras 103 can be fixed, such as when the camera 103 is part of a wall, lamp post and ceiling installation, or the location of the camera 103 can change with time, such as is the case of installations of the camera 103 on vehicles, robots or drones. Such cameras 103 take pictures of a scene 115, a person 208, or an object of interest within a specific field of view.

In some embodiments in which an indoor camera 202 is part of the system 100, the indoor camera is also connected to a cellular telephone transceiver.

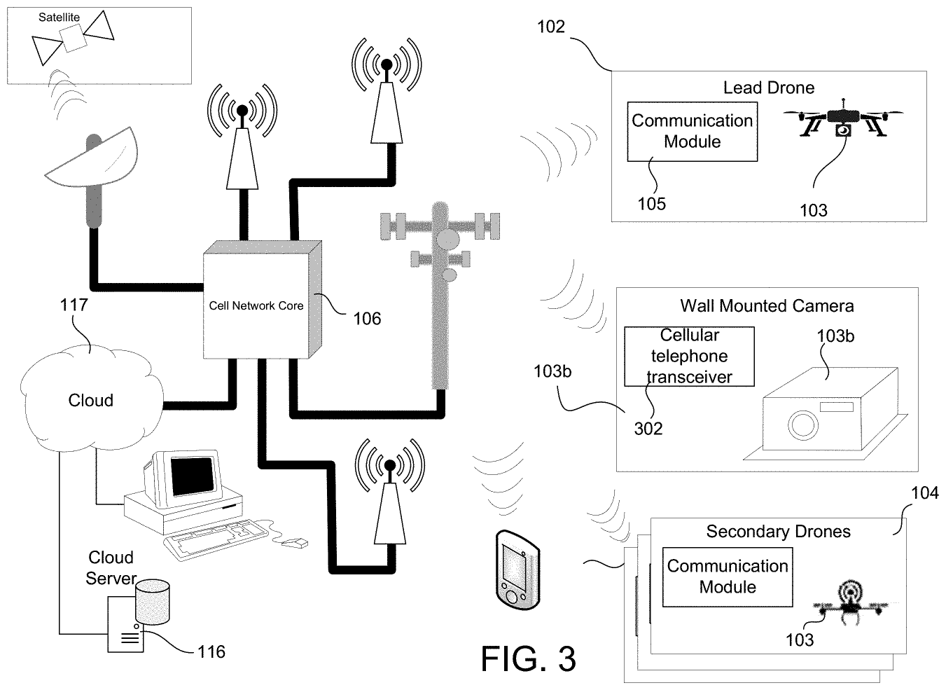

FIG. 3 is an illustration of a system 100. A camera, such as the camera 103b is mounted on the wall 208 (see FIG. 2) or the camera 103a is mounted within the drone 102 with a cellular telephone transceiver 302 to which the camera 103b is coupled. One or more of the drones 102, 104 has a camera 103 capable of taking a relatively high resolution photograph of the earth and the features on the earth below the drones 102, 104.

In some embodiments, using a technique known as “Image fitting”, the image of an area map area can be fit within the picture. Objects within the picture can then be identified and correlated with objects within the image of the area map. Thus, the target asset can be accurately located within the area map and/or with respect to known locations of other features and/or objects identified within the picture that correlate with features and/or objects having known locations in the image of the map. Some embodiments use sophisticated image processing algorithms that attempt to do pattern matching, image rotation and in some embodiments, scaling, to find the best fit. In some cases, the picture is digitally rotated and/or scaled to fit the image of the area map to the picture. In other embodiments the image of the area map can be digitally rotated and/or scaled to match the orientation and relative dimensions of the picture. Accordingly, upon finding a “best fit”, the system 100 can provide the location of a target asset with respect to features and objects having known locations within the image of the map.

Other technologies, such as facial feature recognition, object detection, etc. are used in some embodiments depending on the particular application of the method and apparatus (e.g., whether locating missing objects, such as a lost car, identifying an empty parking space, finding a desired person, etc.).

In some such embodiments of the disclosed method and apparatus, machine learning (ML) algorithms are used for object recognition prior to determining the location of a target asset and to location tracking. In other embodiments, deep neural networks (DNNs) are used for object detection. In other embodiments, one or more AI algorithms for performing facial recognition are used to detect human images. For moving target assets, a location tracking algorithm based on image rotation and in some embodiments on scaling, can be used to update the target asset's location on a per image frame basis.

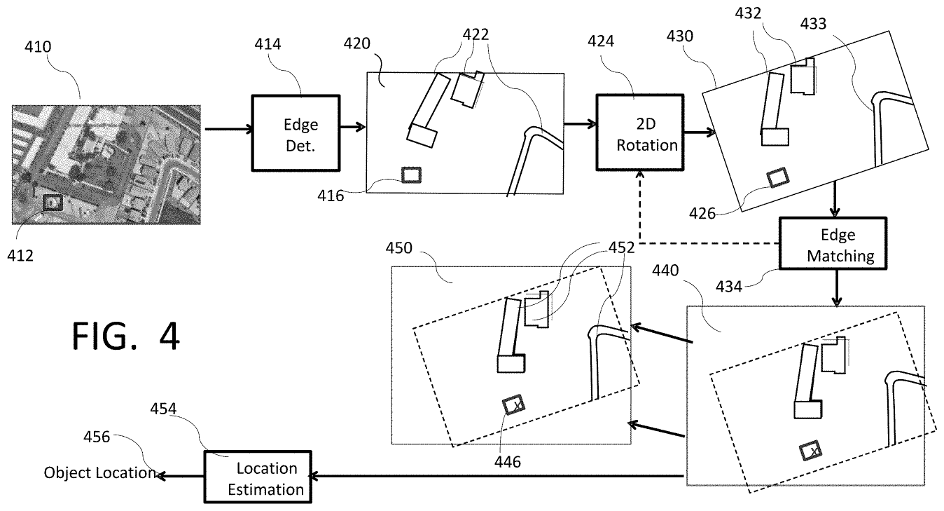

FIG. 4 shows an example of 2D rotation-based location tracking steps when the area of interest in right below the camera field of view. The figure shows an exemplary image 410 taken by a camera on top of the tracking or localization area. The object of interest for location tracking or positioning, is a van parked next to a building on a parking lot. It is assumed that the Van of interest has been identified by an object detection mechanism, for example object detection Neural Network architecture based on, Sliding Window [1], R_CNN (Regional CNN), Histogram Oriented Gradients (HOG) [2] , YOLA [3]. This mechanism draws a box 412 around the detected object of interest. In one embodiment, once the object is spatially identified on the picture, the next step is to perform an Edge Detection 414, mechanism. Edge Detection 414, basically find boundaries across specific objects such as roads, building 422, etc. The number and variety of the objects that edge detected may vary in different embodiments. These edges can be obtained by various AI techniques such as specific filters in a convolutional Neural Network (CNN) architecture. The box containing the object of interest 416 is also transferred to the diagram 420, while other image details can be removed. This simplification can greatly help with the processing load of image rotation on step 444. Step 424 performs a 2D rotation of the image 420 that is simplified with a subset of edges. In one embodiment of this invention, 2D rotation 424 mechanism start with small steps and rotate the diagram 420 to its rotated version 430. Then the edge matching block 434 electronically overlays the image 430 on top of the map 440 and try to find difference between the two images. In some embodiments the EDGE Matching process creates an edge detection process to identify the edges of the equivalent buildings 432, roads 433, and objects on the map. At the output of this process a simplified version of the map 440 is created for comparison with the image 430. This is shown in FIG. 4, as the image 450. The mechanism in FIG. 4 then tries to compare the rotated image 430 with the simplified maps 450, by finding the difference between pixels of both image and adjusts rotation angle and image scale to minimize the difference. This difference may be defined as an error function that can be minimized through various algorithms such as Gradient Descent (GD) algorithm. This error minimization may be considered as an iterative process that minimizes the gradient between the two images. In another embodiment the error function can be a defined using statistical machine learning algorithms such as K-nearest neighbors. Once the error function is minimized the location of object can be identified through the location of the box 426 on the image 450, i.e., the box 446. This task is performed by a location estimation block 454.

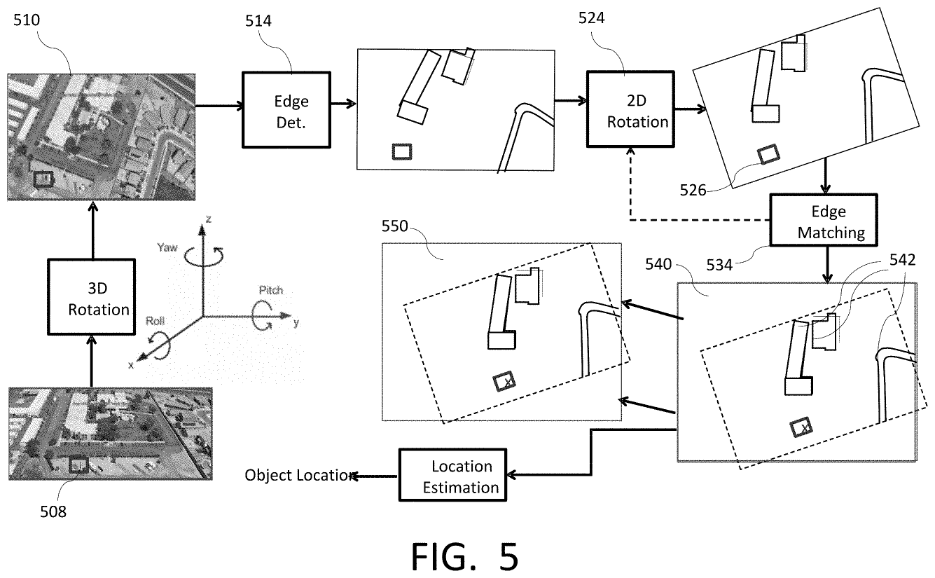

FIG. 5 shows an example of 3D rotation-based location tracking steps when the area of interest in not below the camera field of view and with an arbitrary slant angle. In one embodiment the initial picture taken by the camera 302, is 3D rotated to create an estimate of the image for the top view angle 510. In many cases this is a complicated process that involves creation of a 3D image of the 2D picture and then rotate it towards the top view or 90° view. In some embodiments, cutting edge Deep Neural Networks (DNNs) such as Autoencoder or a Generative Adversarial Network (GAN) [4] might be used to perform the task of 3D rotation.

In one embodiment, after the 3D rotation of the image the processing is similar to FIG. 4. In this case an edge detection is performed by module 514 followed by a 2D rotation 524 and edge matching 534 with the map 540, or its simplification 550. After the feedback mechanism and error minimization, location of object of interest is then identified by locating box 526 on map 550.

Although the disclosed method and apparatus is described above in terms of various examples of embodiments and implementations, it should be understood that the particular features, aspects and functionality described in one or more of the individual embodiments are not limited in their applicability to the particular embodiment with which they are described. Thus, the breadth and scope of the claimed invention should not be limited by any of the examples provided in describing the above disclosed embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide examples of instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosed method and apparatus may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described with the aid of block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. An image processing system, comprising:
(a) a collection of outdoor cameras on fixed or mobile platforms; and
(b) a processor within a cloud connected to the internet and in communication with the collection of outdoor cameras, the processor configured to use images received from the collection of outdoor cameras and compare the received images to other images taken by a satellite and to use image recognition algorithms to identify a target asset and track the target asset based on the comparison of images captured by at least one of the collection of outdoor cameras.
